(19) United States
(12) Patent Application Publication
(10) Pub. No.: US 2007/0044354 A1
(43) Pub. Date: Mar. 1, 2007

(54) Pop label and electronic device

(75) Inventors: Yukio Hiramoto, Saitama (JP); Takahiro Omata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/503,150

(22) Filed: Aug. 14, 2006

(30) Foreign Application Priority Data
Aug. 24, 2005 (JP) P2005-243222

(51) Int. Cl. G09F 1/00

(52) U.S. Cl. 40/124.13

(57) ABSTRACT

A POP label for use on a product having a pair of selectively concealed faces which can be selectively concealed when a member of the product is installed or closed, includes an application segment applied to one of the selectively concealed faces; an appealing feature display segment for displaying an appealing feature of the product; and a displacement segment interposed between the appealing feature display segment and the application segment, for displacing the appealing feature display segment into and out of a space defined between the selectively concealed faces.

### CROSS REFERENCES TO RELATED APPLICATIONS

The present invention contains subject matter related to Japanese Patent Application JP 2005-243222 filed with the Japanese Patent Office on Aug. 24, 2005, the entire contents of which being incorporated herein by reference.

### BACKGROUND OF THE INVENTION

1. Field of the Invention

The present invention relates to a POP (Point Of Purchase) label and an electronic device which are suitable for use as a car audio unit POP label and a car audio unit, respectively.

2. Description of the Related Art

It has been widely practiced to apply POP stickers to the front faces of car audio units in the manufacturing process to provide a simple indication of appealing features of the car audio units at shops in the past. When the car audio units are displayed for sale, the applied POP stickers give an advertisement about the appealing features to customers in the shop.

However, since the POP sticker is applied to the front face of each car audio unit, it hides part of the car audio unit displayed in the shop, and tends to keep the overall design of the car audio unit out of balance. Therefore, though the POP sticker is effective to attract customers, it makes it difficult to convey the design of the car audio unit, which is one of the important appeals, to the customers.

One known device for displaying the POP advertisement of a product without hiding the product that is being displayed is a POP stand assembled and mounted on top of the product (see, for example, Japanese Utility Model Registration No. 3041897).

### SUMMARY OF THE INVENTION

The POP stand is mounted as an externally projecting piece on the product, and hence its unity with the product is comparatively small. If a POP stand is installed on a car audio unit in its manufacturing process, then the POP stand tends to be dislodged or damaged during shipment. For these reasons, the known POP stand is not applicable to car audio units.

The present invention has been made in view of the above, to provide a pop label and electronic device which improve the unity with a product.

According to an embodiment of the present invention, there is provided a POP label for use on a product having a pair of selectively concealed faces which can be selectively concealed when a member of the product is installed or closed, including an application segment applied to one of the selectively concealed faces, an appealing feature display segment for displaying an appealing feature of the product, and a displacement segment interposed between the appealing feature display segment and the application segment, for displacing the appealing feature display segment into and out of a space defined between the selectively concealed faces.

When the product is displayed for sale in the shop, the appealing feature display segment is displaced out of the space between the selectively concealed faces and displayed outside of the space. When the product is delivered, the appealing feature display segment is collapsed and stored in the space. The POP label is thus combined in high unity with the product.

According to another embodiment of the present invention, there is also provided an electronic device with a POP label applied thereto, the electronic device having a pair of selectively concealed faces which can be selectively concealed when a member of the product is installed or closed, the POP label including an application segment applied to one of the selectively concealed faces, an appealing feature display segment for displaying an appealing feature of the product, and a displacement segment interposed between the appealing feature display segment and the application segment, for displacing the appealing feature display segment into and out of a space defined between the selectively concealed faces.

When the electronic device is displayed for sale in the shop, the appealing feature display segment is displayed outside of the space. When the product is delivered, the appealing feature display segment is collapsed and stored in the space.

The electronic device is thus combined in high unity with the POP label.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a perspective view of a car audio unit;

FIG. 2 is a perspective view of the car audio unit with a POP label according to another embodiment of the present invention being applied thereto;

FIGS. 3A and 3B are front and rear elevational views, respectively, showing the shape of the POP label;

FIG. 4 is a fragmentary perspective view showing the manner in which the POP label is applied to the car audio unit;

FIG. 5 is a fragmentary cross-sectional view showing the manner in which the POP label is applied to the car audio unit;

FIG. 6A is a fragmentary perspective view showing how to store the POP label on the car audio unit, and FIG. 6B is a fragmentary cross-sectional view showing how to store the POP label on the car audio unit;

FIG. 7A is a fragmentary perspective view showing the POP label that has been fully collapsed and held on the car audio unit, and FIG. 7B is a fragmentary cross-sectional view showing the POP label that has been fully collapsed on the car audio unit;

FIG. 8 is a fragmentary cross-sectional view showing the manner in which the POP label is unfolded from the collapsed position to a displayed position;

FIG. 9 is a fragmentary cross-sectional view showing how to install an operating panel after the POP label is unfolded;

FIG. 10 is a fragmentary cross-sectional view showing the operating panel that has been installed in position;

FIG. 11 is an exploded perspective view showing the manner how to package the car audio unit;

FIG. 12 is an exploded perspective view showing the manner how to display the car audio unit; and

FIGS. 13A and 13B are a front elevational view and a perspective view, respectively, of a POP label according to another embodiment of the present invention.

### DETAILED DESCRIPTION OF THE PREFERRED EMBODIMENTS

Referring to the drawings, an embodiment of the present invention is hereinafter described.

### (1) Overall Structure of Car Audio Unit

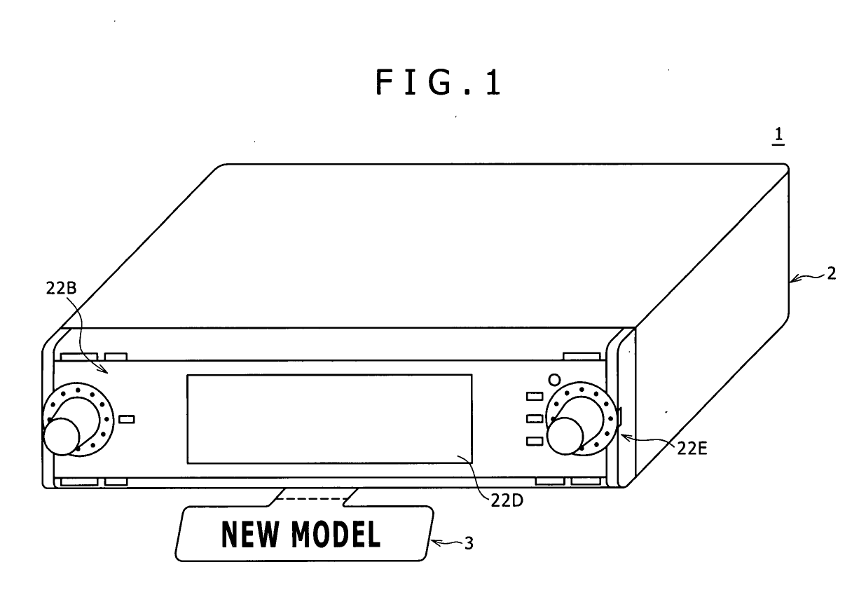

As shown in FIG. 1, a car audio unit 2 has a POP (Point Of Purchase) label 3 according to an embodiment of the present invention which is applied thereto.

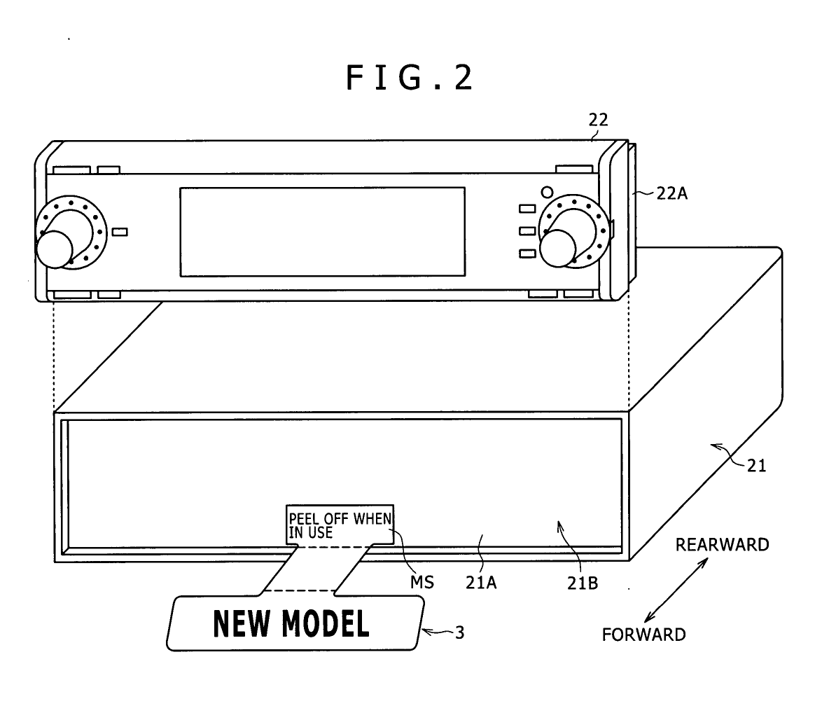

As shown in FIG. 2, the car audio unit 2 includes a detachable main body 21 and an operating panel 22 removably mounted on a front end of the main body 21. It is assumed in FIG. 2 that a forward direction extends toward the front end of the main body 21 and a rearward direction extends opposite to the forward direction.

The main body 21 has a recess 21A defined in the front end thereof which is open in the forward direction. The operating panel 22 has a land 22A on its rear face which is complementary in shape to the recess 21A. When the land 22A is fitted in the recess 21A, the operating panel 22 is installed on the main body 21. The operating panel 22 and the main body 21 are locked together by a pair of hooks, not shown, provided in the recess 21A and on the land 22A, respectively.

With the operating panel 22 removed from the main body 21, the POP label 3 is applied to a lower portion of a central region of a front face 21B of the main body 21, which serves as the bottom of the recess 21A, that faces in the forward direction. Then, the operating panel 22 is installed on the main body 21 with the POP label 3 applied thereto, as shown in FIG. 1. Thereafter, the car audio unit 2 is displayed for sale.

When the car audio unit 2 is purchased by a customer (hereinafter referred to as “user”), the car audio unit 2 with the POP label 3 applied thereto is handed or delivered to the user. Then, the user peels off the POP label 3 from the car audio unit 2.

### (2) POP Label

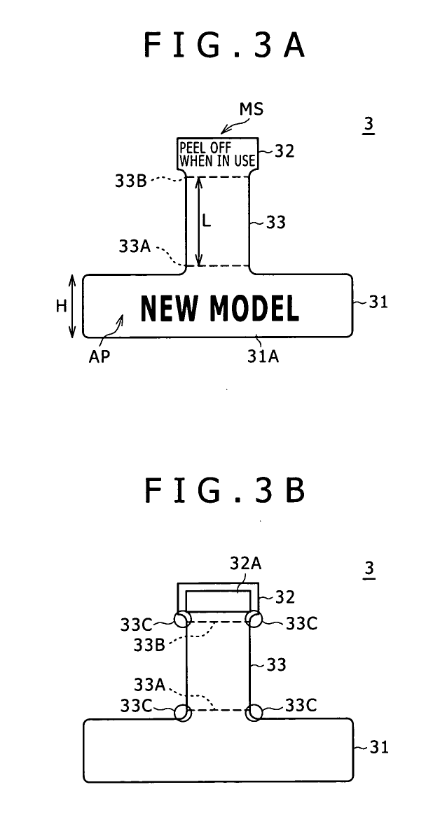

Specific details of the POP label 3 will be described below with reference to FIGS. 3A and 3B. The front face of the POP label 3 which faces in the forward direction when the POP label 3 is applied to the car audio unit 2 is shown in FIG. 3A, and the rear face of the POP label 3 which faces in the rearward direction when the POP label 3 is applied to the car audio unit 2 is shown in FIG. 3B.

As shown in FIGS. 3A and 3B, the POP label 3 is in the form of a plate, and includes a substantially rectangular appealing feature display segment 31, an application segment 32, and a displacement segment 33.

The appealing feature display segment 31 displays an appealing feature AP expressed by characters or figures or both as indicating merits, advantages, a special price of the car audio unit 2. In the illustrated embodiment, characters “NEW MODEL” indicating that the car audio unit 2 is a new model are printed on the appealing feature display segment 31.

When the POP label 3 applied to the car audio unit 2 is displayed in the shop, it enables a customer who has visually recognized the appealing feature display segment 31 to know that the car audio unit 2 is a new model. Therefore, the POP label 3 with the appealing feature display segment 31 gives an advertisement to make the customer interested in the car audio unit 2 and also leads to a sales promotional activity for giving the customer an opportunity to consider the purchase of the car audio unit 2.

A double-sided adhesive tape 32A with a peel-off sheet is applied to the rear face of the application segment 32. When the peel-off sheet is peeled off the double-sided adhesive tape 32A, the application segment 32 can be applied to a desired position on the car audio unit 2 by an exposed adhesive surface of the double-sided adhesive tape 32A.

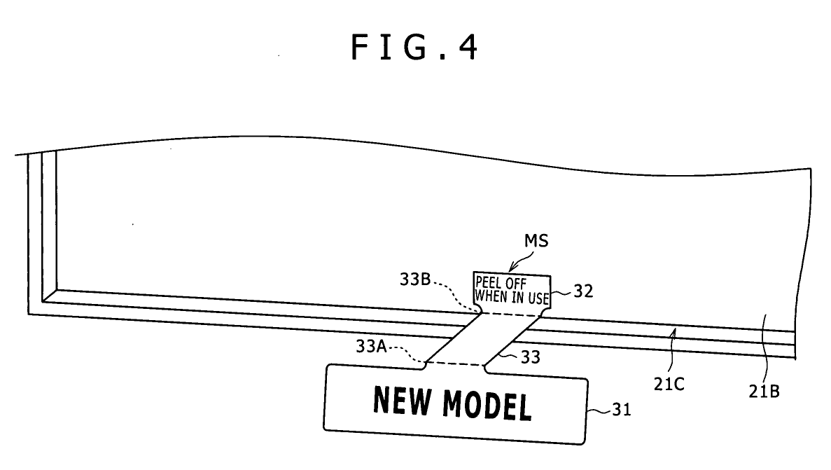

A prompt message MS “PEEL OFF WHEN IN USE” is printed on the front face of the application segment 32, prompting the user who has purchased the car audio unit 2 to peel off the POP label 3 when the car audio unit 2 is to be used. As shown in FIG. 4, when the operating panel 22 is removed from the main body 21, the prompt message MS on the front face of the application segment 32 can be visually recognized by the user.

Therefore, when the car audio unit 2 is bought by the user and is actually used thereby, the user is prompted to peel off the POP label 3 from the main body 21.

The application segment 32 is applied to the front face 21B of the main body 21 which is concealed by the operating panel 22 that is installed when the car audio unit 2 is in use. When the car audio unit 2 is in use, the front face 21B of the main body 21 is not exposed, and hence any adhesive residuals which may remain on the front face 21B after the POP label 3 is peeled off are concealed from view unlike the POP sticker in the past which would be applied to a front face 22B (see FIG. 1) of the operating panel 22 of the car audio unit 2. Furthermore, since the entire rear face of the appealing feature display segment 31 of the POP label 3 does not need to be an adhesive surface unlike the POP sticker in the past, the application segment 32 may be small in size, and any adhesive residuals which may remain on the front face 21B after the POP label 3 is peeled off may be less visible.

The displacement segment 33 (see FIGS. 3A and 3B) is provided to displace the appealing feature display segment 31 as described later. The displacement segment 33 has a peak fold 33A on its lower end and a valley fold 33B on its upper end. Specifically, the POP label 3 has grooves or recesses defined therein along the peak fold 33A and the valley fold 33B such that when the POP label 3 has its face side facing upwardly, the peak fold 33A will be folded into a convex corner, and the valley fold 33B will be folded into a concave corner.

As shown in FIG. 4, the POP label 3 is folded into a convex corner along the peak fold 33A and also folded into a concave corner along the valley fold 33B. The application segment 32 is applied to the lower central region of the front face 21B of the main body 21, with the valley fold 33B extending along a lower edge 21C of the front face 21B.

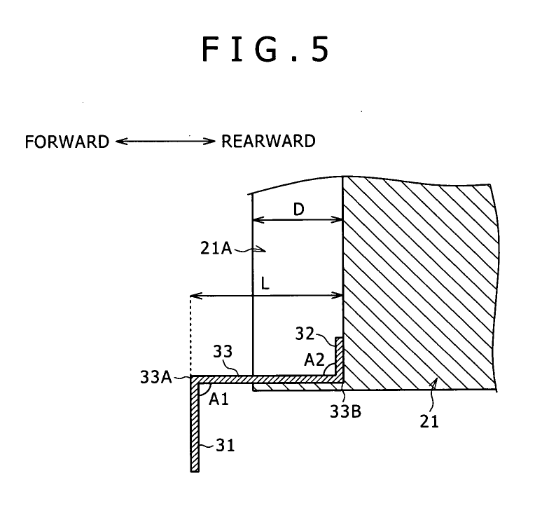

As shown in FIG. 5, while no pressure is being applied to the POP label 3, the POP label 3 is folded at about a right angle A1 along the peak fold 33A and at about a right angle A2 along the valley fold 33B. The displacement segment 33 has a length L greater than the depth D of the recess 21A. Therefore, the appealing feature display segment 31 projects forwardly from the main body 21.

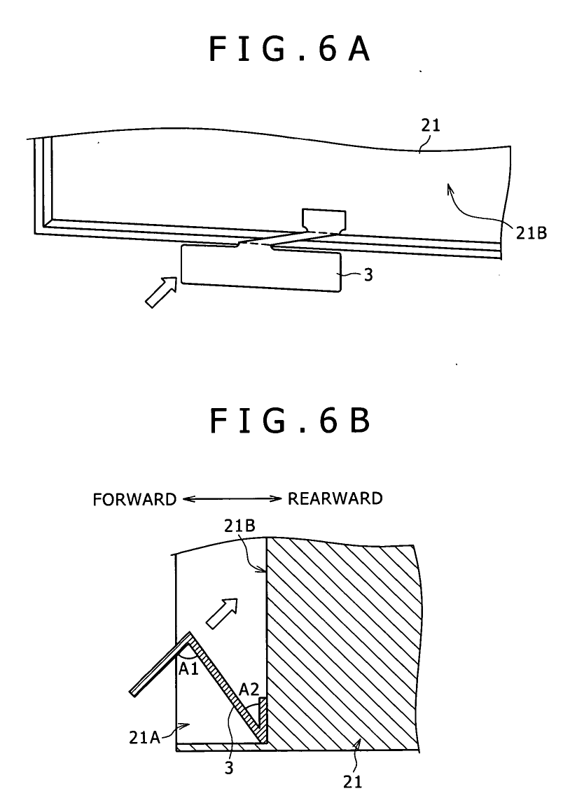

As shown in FIGS. 6A and 6B, since the displacement segment 33 has the peak fold 33A and the valley fold 33B, rather than folds of the same type, e.g., peak folds, the POP label 3 can easily be collapsed into a bellows configuration simply by lightly pushing the appealing feature display segment 31 obliquely upwardly.

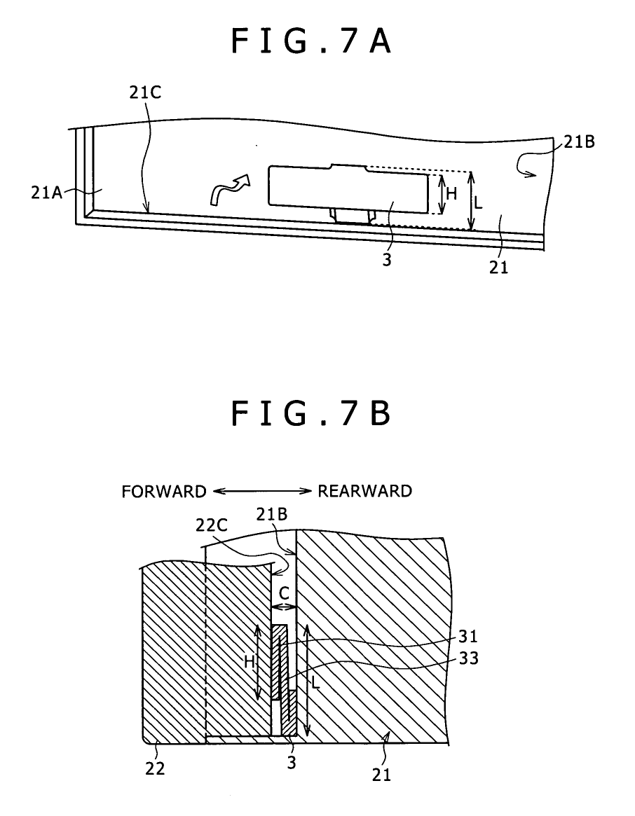

As shown in FIGS. 7A and 7B, when the operating panel 22 is installed on the main body 21 with the POP label 3 being collapsed, the POP label 3 is held in a gap C defined between the front face 21B of the main body 21 and the rear face 22C of the operating panel 22.

Therefore, the POP label 3 is not exposed out of the car audio unit 2, but is sandwiched between the main body 21 and the operating panel 22 for better unity with the car audio unit 2. The POP label 3 is protected by the car audio unit 2 against possible damage under shocks during delivery of the car audio unit 2.

As shown in FIG. 7B, the length L of the displacement segment 33 (see FIGS. 3A and 3B) is smaller than the height H of the appealing feature display segment H. Consequently, the appealing feature display segment H does not project out from the lower edge 21C of the front face 21B, but the POP label 3 is neatly placed in its entirety within the recess 21A of the main body 21.

The peak fold 33A and the valley fold 33B of the displacement segment 33 extend parallel to a lower edge 31A (FIG. 3A) of the appealing feature display segment 31. The application segment 32 is applied to the front face 21B such that the lower edge of the application segment 32 extends along the lower edge 21C of the front face 21B. When the POP label 3 is folded over on itself, it is collapsed in a most compact form without the substantially rectangular appealing feature display segment 31 being tilted as shown in FIG. 7A. When the POP label 3 is unfolded to project from the front face 21B, the appealing feature display segment 31 lies parallel to the lower edge 21C of the front face 21B, as shown in FIG. 4.

Therefore, simply by applying the application segment 32 to the front face 21B such that the valley fold 33B extends along the lower edge 21C of the front face 21B, the appealing feature display segment 31 can display its appealing feature AP without being tilted.

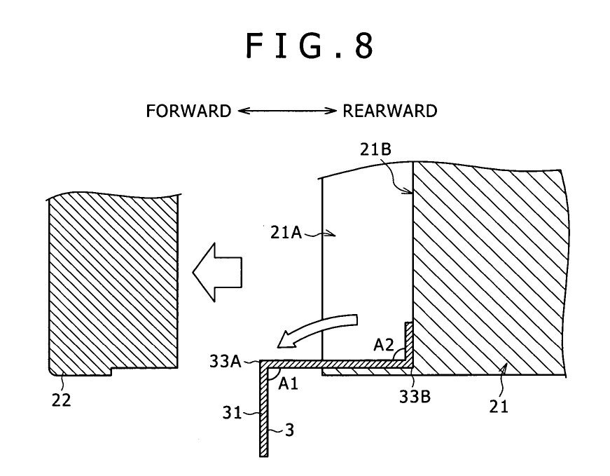

The POP label 3 is made of “YUPO”™ which is a resilient material. Consequently, when the operating panel 22 is removed from the main body 21, as shown in FIG. 8, the POP label 3 automatically spreads under its own resiliency, pushing the appealing feature display segment 31 forwardly until the displacement segment 33 is folded at about the right angle A1 along the peak fold 33A and at about the right angle A2 along the valley fold 33B, in essentially the same position as before the POP label 3 is collapsed and stored in the recess 21A (FIG. 5).

Therefore, substantially at the same time that the operating panel 22 is removed from the main body 21, the appealing feature display segment 31 automatically pops out of the recess 21A to attract attention. The person who has removed the operating panel 22 from the main body 21 can thus visually recognize the appealing feature display segment 31 as it moves out of the recess 21A.

When the operating panel 22 is removed by the user who bought the car audio unit 2, the appealing feature display segment 31 makes the user recognize the appealing feature AP of the car audio unit 2 to give the user better satisfaction for the car audio unit 2. When the operating panel 22 is removed by the salesperson of the shop which sells the car audio unit 2, the presence of the POP label 3 is reliably recognized by the salesperson, guiding the salesperson to show the appealing feature display segment 31 when the car audio unit 2 is to be displayed in the shop.

Because the POP label 3 is made of “YUPO”™, the POP label 3 is prevented from being deformed due to environmental changes such as humidity and temperature changes, and is of high mechanical strength and durability.

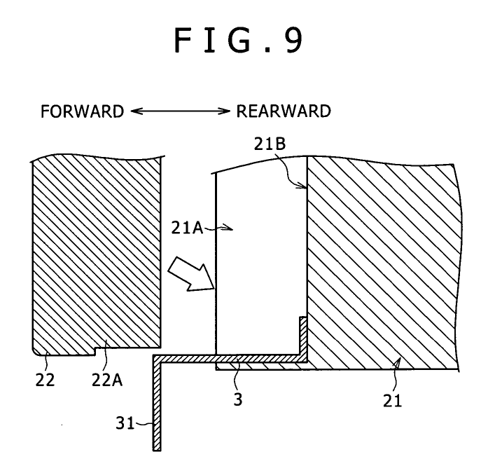

For installing the operating panel 22 onto the main body 21, as shown in FIG. 9, the land 22a of the operating panel 22 is fitted substantially horizontally into the recess 21A while moving over the displacement segment 33 of the POP label 3 which is being stretched.

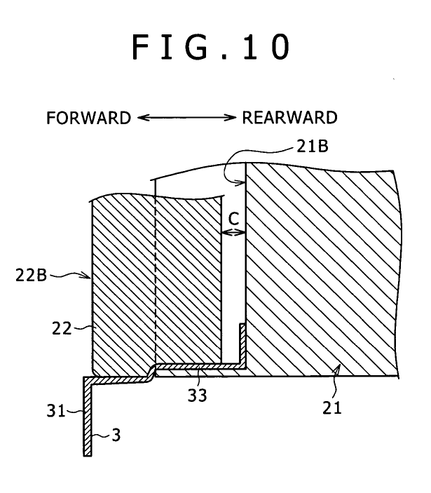

As a result, as shown in FIG. 10, the displacement segment 33 extends from the front face 21B of the main body 21 toward the front face 22B of the operating panel 22, along the lower edge of the operating panel 22, and is sandwiched between the main body 21 and the operating panel 22 for increased integrity with the car audio unit 2. The appealing feature display segment 31 that is positioned on the distal end of the displacement segment 33 slightly projects from the front face 22B of the operating panel 22 and hangs downwardly therefrom.

The POP label 3 thus has the appealing feature display segment 31 and a portion of the displacement segment 33 exposed, with the other portion thereof integrally retained in the car audio unit 2. Therefore, when the car audio unit 2 is displayed for sale, the POP label 3 will not be detached from the car audio unit 2 under external shocks applied to the car audio unit 2.

Since the appealing feature display segment 31 is displayed at a position slightly projecting from the front face 22B of the operating panel 22, when the car audio unit 2 is displayed in the shop, the appealing feature display segment 31 is made more visible than the POP sticker in the past that would be applied to the front face 22B in full contact therewith, making it possible to effectively advertise the car audio unit 2 in a manner to differentiate itself from other products that are simultaneously and similarly displayed for sale.

The POP label 3 has the appealing feature display segment 31 displayed while hanging down from the car audio unit 2. Therefore, the appealing feature display segment 31 is displayed without overlapping the front face 22B. As the appealing feature display segment 31 does not conceal the front face 22B, the appealing feature display segment 31 does not visually obstruct the design of the front face 22B while displaying itself.

Because the POP label 3 is not directly applied to the front face 22B, the appealing feature display segment 31 has its area determined freely without regard to the area of the front face 22B. Consequently, the appealing feature display segment 31 can have an area greater than POP stickers in the past. Using the large area of the appealing feature display segment 31, the POP label 3 can express its image in greater detail and can advertise the appealing feature AP effectively through various expressions.

The POP label 3 has arcuate corners 33C (FIG. 3B), rather than sharp corners, near the peak fold 33A and the valley fold 33B. As the POP label 3 has no sharp corners near the peak fold 33A and the valley fold 33B, no stresses concentrate on the corners when the POP label 3 is folded and unfolded. Therefore, the POP label 3 is prevented from being easily damaged when it is folded and unfolded.

### (3) Holding of the POP Label when the Car Audio Unit is Packaged

When the POP label 3 that has been applied to the car audio unit 2 in its manufacturing process is delivered to the shop together with the car audio unit 2, the POP label 3 is displayed in the shop in combination with the car audio unit 2. A process from the time when the POP label 3 is applied to the car audio unit 2 to the time when the car audio unit 2 is packaged will be described below.

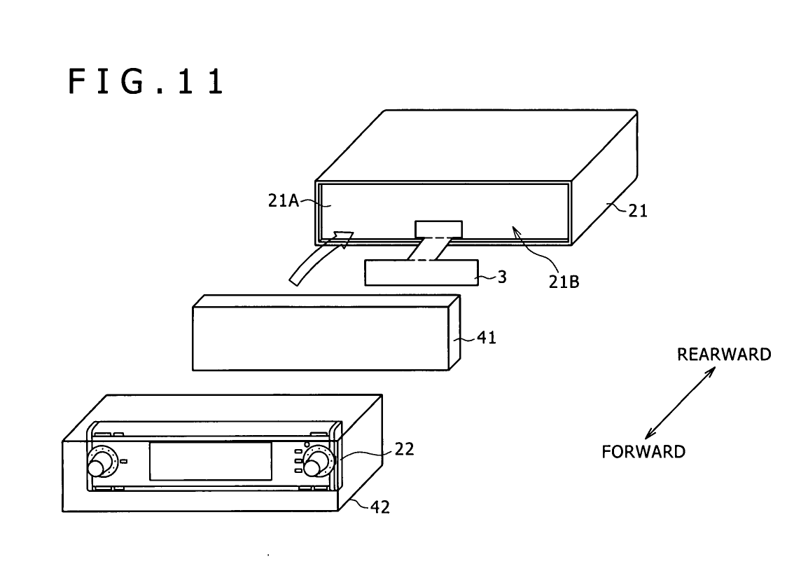

As shown in FIG. 11, the detachable main body 21 and the operating panel 22 of the car audio unit 2 are separately packaged.

The POP label 3 is applied to the front face 21B of the main body 21, and a protective spacer 41 of corrugated cardboard is fitted in the recess 21A to protect the recess 21A.

When the protective spacer 41 is fully fitted in the recess 21A, the POP label 3 is collapsed and retained between the front face 21B and the protective spacer 41. Therefore, the POP label 3 is not exposed out of the car audio unit 2, but is sandwiched and protected between the recess 21A and the protective spacer 41 against damage due to shocks which may be applied while the car audio unit 2 is being delivered.

The main body 21 is placed in a plastic bag of PE (polyethylene) or PP (polypropylene). The operating panel 22 is placed in a dedicated operating panel case 42. The main body 21 and the operating panel 22 are then protected by cushioning materials and packaged in an outer box of corrugated cardboard, not shown.

Electronic devices such as car audio units, etc. are usually easily vulnerable to high humidity, and hence are placed in plastic bags for humidity resistance and then packed in outer boxes. If a POP stand is exposed out of the car audio unit 2, then the POP stand tends to be detached when the car audio unit 2 is packaged and unpackaged as it is placed into and out of the plastic bag. However, the POP label 3 is free of such trouble because it is not exposed out of the car audio unit 2.

Electronic devices such as car audio units, etc. are also vulnerable to shocks, and are usually placed in outer boxes with cushioning materials such as foamed polystyrene placed around the electronic devices for shock resistance. Those cushioning materials fill up the space in the outer boxes, failing to provide an extra space for accommodating a POP stand outside of the car audio unit 2. In addition, since the car audio unit 2 is mostly in the form of a casing free of convexities and concavities, a space for accommodating a POP stand is not provided around the car audio unit 2.

However, the POP label 3 can be held in the gap C that is defined by a detaching/attaching mechanism constructed of the main body 21 and the operating panel 22. Specifically, the POP label 3 is collapsed and retained in the gap C that is defined between the recess 21A, which serves as part of the detaching/attaching mechanism, and the protective spacer 41 that protects the recess 21A.

The operating panel 22 has a display panel 22D and control elements 22E such as control dials and buttons on the front face 22B (FIG. 1). Heretofore, a POP sticker in the past is applied to the display panel 22D, and the applied POP sticker makes it impossible to inspect the display panel 22D to check if the display panel 22D can function normally or not in a final inspection process after the POP sticker has been applied. The POP label 3 is free of such a problem because the POP label 3 does not conceal the front face 22B of the operating panel 22.

### (4) The Display of the POP Label after the Car Audio Unit is Displayed in the Shop

A process of unpackaging the car audio unit 2 delivered to the shop, displaying the car audio unit 2 in the shop, and displaying the POP label 3 will be described below.

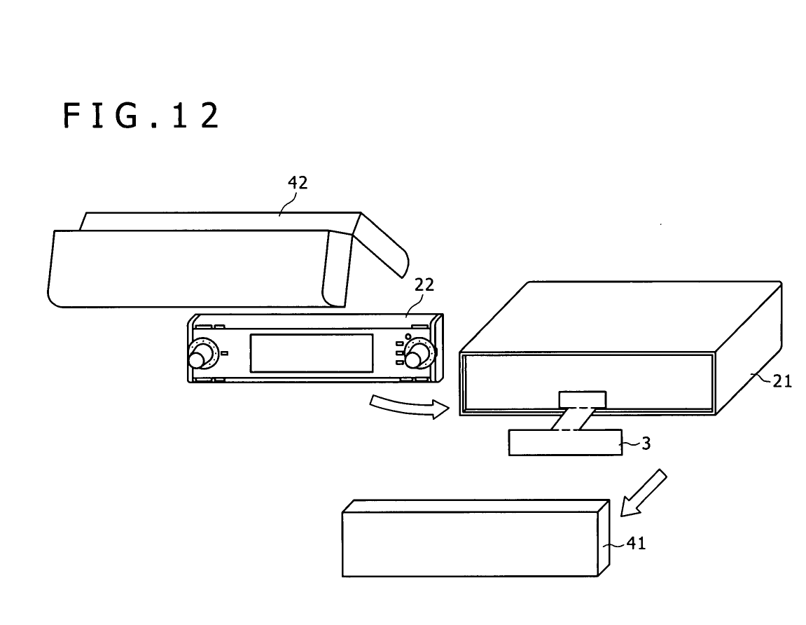

As shown in FIG. 12, when the car audio unit 2 is unpackaged in the shop, the protective spacer 41 fitted in the recess 21A of the main body 21 is removed, the operating panel 22 is removed from the operating panel case 42, and the operating panel 22 is attached to the main body 21.

At the same time that the protective spacer 41 is removed, the appealing feature display segment 31 can be displaced to its display position. Therefore, when a normal sequence of unpackaging the car audio unit 2 and installing the operating panel 22 on the main body 21 is carried out, the appealing feature display segment 31 is almost automatically displayed. The appealing feature display segment 31 is thus prevented from being left undisplayed unlike the separate POP stand in the past that would need to be separately applied in position. Consequently, the appealing feature display segment 31 can reliably be displayed in the shop.

Usually, the main body 21 and the operating panel 22 are fastened to each other by screws (not shown) and displayed inseparably in the shop. With the operating panel 22 secured to the main body 21, the displacement segment 33 (FIG. 10) is sandwiched and fixed between the main body 21 and the operating panel 22.

The car audio unit 2 is displayed in the shop with the operating panel 22 unremovably secured thereto and also with the displacement segment 33 sandwiched between the main body 21 and the operating panel 22. The POP label 3 is thus highly integrally combined with the car audio unit 2. Even if the appealing feature display segment 31 is forcibly pulled, the pulling force is not transmitted to the application segment 32. Therefore, the POP label 3 may not be detached by being pulled. Furthermore, the POP label 3 may not be torn off by usual human manual forces as it is made of the strong material of “YUPO”™.

When the operating panel 22 is mounted on the main body 21, the application segment 32 of the POP label 3 is not exposed. Therefore, customers in the shop are unable to visually recognize the applied state of the POP label 3, and hence are kept from tampering with and peeling off the POP label 3 out of curiosity.

The POP label 3 is effective to keep customers in the shop from tampering with and removing the POP label 3. Even if the POP label 3 is tampered with and pulled, it is not torn off and cannot be removed. Therefore, the appealing feature display segment 31 remains displayed over a long period of time for an increased advertisement effect.

### (5) Operation and Advantages

The application segment 32 of the POP label 3 is applied to the front face 21B, which serves as a selectively concealed face, of the main body 21 on which the operating panel 21 is mounted, and the appealing feature display segment 31 of the POP label 3, which displays the appealing feature of the car audio unit 2, is freely displaceable by the displacement segment 33 into and out of the gap C that is defined between the front face 21B and the rear face 22C, which serves as another selectively concealed face, of the operating panel 22.

When the appealing feature display segment 31 is displaced into the gap C, it is sandwiched between the main body 21 and the operating panel 22 and protected integrally with the car audio unit 2 without being exposed out of the car audio unit 2. The POP label 3 is thus prevented from being damaged or detached due to external shocks during the period from the time when the POP label 3 is applied to the car audio unit 2 until the time when the car audio unit 2 is displayed in the shop.

The POP label 3 is applied to the car audio unit 2 at a predetermined position thereon in the process of manufacturing the car audio unit 2. Therefore, the appealing feature display segment 31 can be displayed at a desired display position matching the design of the car audio unit 2.

When the operating panel 22 is removed from the main body 21, the displacement segment 33 causes the appealing feature display segment 31 to be displaced out of the gap C between the front face 21B of the main body 21 and the rear face 22C of the operating panel 22.

When the car audio unit 2 is displayed in the shop, the appealing feature display segment 31 is displaced into the desired display position. When the operating panel 22 is installed back on the main body 21, the appealing feature display segment 31 is displayed in integrity with the car audio unit 2 by extending from the front face 21B and the gap C between the main body 21 and the operating panel 22.

The POP label 3 extends through the car audio unit 2 and has the appealing feature display segment 31 displayed out of the car audio unit 2. For removing the POP label 3 under this condition, it is necessary to apply forces inside of the car audio unit 2. It is thus difficult to remove the POP label 3 with external physical forces unlike the POP stand in the past which would be assembled and partly applied to the car audio unit 2.

The POP label 3 has the peak fold 33A and the valley fold 33B in the displacement segment 33. When the protective spacer 41 is fitted into the recess 21A, the POP label 3 is easily collapsed into a bellows configuration as it is folded at the peak fold 33A and the valley fold 33B, under the applied pressure from the protective spacer 41. At the same time that the protective spacer 41 is removed, the POP label 3 automatically unfolds, causing the appealing feature display segment 31 to pop out into the position out of the car audio unit 2. Therefore, the process of storing and displaying the POP label 3 is highly simple.

When the salesperson of the shop carries out the usual process of unpackaging and assembling the car audio unit 2, including installing the operating panel 22 on the main body 21, the appealing feature display segment 31 is displayed without special concern on the part of the salesperson, so that the car audio unit 2 can properly be displayed in the shop.

The POP label 3 can be collapsed into a highly compact configuration by the peak fold 33A and the valley fold 33B, and stored in the gap C that is defined between the main body 21 and the protective spacer 41 that is fitted, instead of the operating panel 22, in the recess 21A.

Furthermore, since the POP label 3 has the appealing feature display segment 31 displayed at a position below the operating panel 22, the POP label 3 does not hide the operating panel 22, and the appealing feature display segment 31 can be displayed over a showcase shelf or a showcase clearance.

After the car audio unit 2 is purchased by the user, the protective spacer 41 is removed from the main body 22. At this time, the application segment 32 applied to the front face 21B is exposed, allowing the user to visually recognize the prompt message MS “PEEL OFF WHEN IN USE” printed on the application segment 32. The user can quickly peel off the POP label 3 prior to using the car audio unit 2. Since the user can peel off the POP label 3 by pulling either the appealing feature display segment 31 or the displacement segment 33, the user does not need to use a fingernail or another sharply pointed tool to forcibly peel off the POP label 3, unlike the POP sticker in the past. Therefore, the POP label 3 can easily be peeled off by the user.

With the above arrangement, the application segment 32 of the POP label 3 is applied to the front face 21B, which serves as a selectively concealed face, of the main body 21 on which the operating panel 22 is mounted, and the appealing feature display segment 31 of the POP label 3 is freely displaceable by the displacement segment 33 into and out of the gap C that is defined between the front face 21B and the rear face 22C, which serves as another selectively concealed face that is paired with the above selectively concealed face, of the operating panel 22. When the car audio unit 2 is delivered, the POP label 3 is stored in the gap C for protection. The POP label 3 is highly integrally combined with the car audio unit 2.

### (6) Other Embodiments

In the above embodiment, the POP label 3 is made of “YUPO”™ which includes PP. However, the POP label 3 may be made of any of various materials including paper, any of various plastic materials including PET (polyethylene terephthalate), and any of various composite materials. If the POP label 3 is made of a plastic material having a modulus of elasticity ranging from 100 MPa to 100 GPa and a thickness ranging from 25 μm to 200 μm, then the appealing feature display segment 31 can automatically pop out under its own resiliency at the same time that the operating panel 22 is removed from the main body 21.

In the above embodiment, the POP label 3 has the peak fold 33A and the valley fold 33B on the displacement segment 33. However, the displacement segment 33 may not need to have folds, but the appealing feature display segment 31 may be rolled and stored in the gap C. If the POP label 3 has folds, then the number of such folds may be adjusted freely depending on the shape and size of the car audio unit 2 to be sold, the size of the gap C, etc.

In the above embodiment, the POP label 3 has the peak fold 33A and the valley fold 33B and is collapsible as it folds in a bellows configuration. However, the POP label 3 may have a succession of like folds, e.g., a succession of peak folds, on the displacement segment 33. When the user performs a simple assistive process of folding and unfolding the displacement segment 33 along such a succession of like folds, the appealing feature display segment 31 can be stored and pulled out.

In the above embodiment, when the operating panel 22 is removed from the main body 21, the POP label 3 is folded at about the right angle A1 along the peak fold 33A and at about the right angle A2 along the valley fold 33B. However, the POP label 3 may be folded at angles A1, A2 which may not be right angles, but may be adjusted freely depending on the material of a POP label, the depth of the grooves or recesses defined along the peak fold 33A and the valley fold 33B and the pressure that is applied to the peak fold 33A and the valley fold 33B when the POP label 3 is stored.

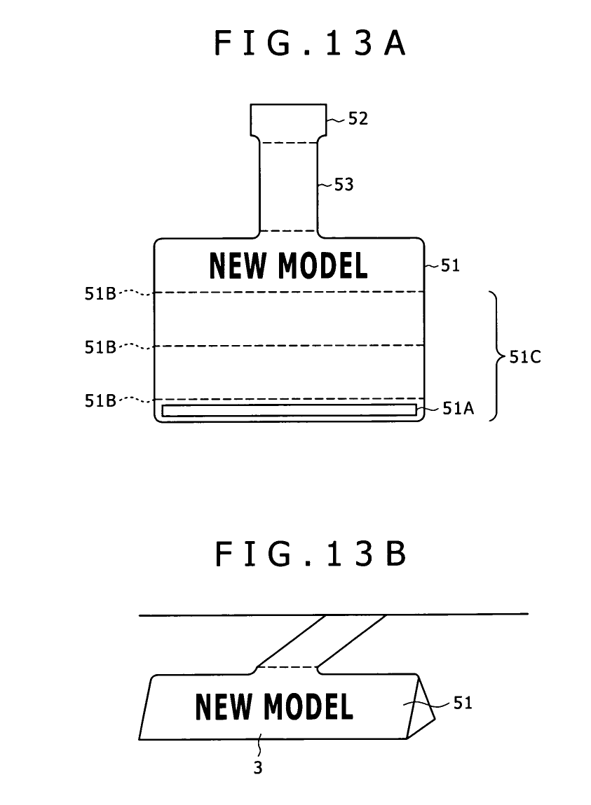

In the above embodiment, the appealing feature display segment 31 is in the form of a substantially rectangular strip. However, the appealing feature display segment 31 is not limited to any shapes, but may be of a circular shape, a triangular shape, or the like, or a three-dimensional shape. For example, as shown in FIGS. 13A and 13B, a POP label may have an application segment 52, a displacement segment 53, and an appealing feature display segment 51 including a triangular prism forming portion 51C which has three peak folds 51B. The triangular prism forming portion 51C is folded along the peak folds 51B into a triangular prism, which retains its three-dimensional shape with a double-sided adhesive tape 51A applied to an upper edge of the appealing feature display segment 51. The three-dimensional appealing feature display segment 51 makes the car audio unit 2 more distinguishable and attractive than other car audio units that are also displayed in the shop, and hence provides an increased advertisement effect.

In the above embodiment, the main body 21 and the operating panel 22 are fastened to each other by screws and displayed inseparably in the shop. However, the main body 21 and the operating panel 22 may not be fastened to each other by screws and may be displayed separably in the shop.

When the operating panel 22 is installed on the main body 21, the application segment 32 of the POP label 3 is not visible to customers in the shop, and customers are unable to recognize where the POP label 3 extends from at a glance. Therefore, customers are likely to try to remove the operating panel 22 to check the POP label 3 or to touch the POP label 3 out of curiosity, and hence are attracted to the car audio unit 2. As a result, customers are likely to be interested in the car audio unit 2.

In the above embodiment, the POP label 3 is applied to the front face 21B which is one of the selectively concealed faces of the main body 21 and the operating panel 22. However, the POP label 3 may be applied to the rear face 22C as another selectively concealed face.

In the above embodiment, the POP label 3 is applied to the front face 21B which is one of the selectively concealed faces of the car audio unit 2 where the main body 21 and the operating panel 22 are separably combined with each other. However, the POP label 3 may be applied to a selectively concealed face of an openable and closable product, such as a refrigerator door or a desk drawer or the like, for example. Specifically, the POP label 3 may be applied to a face which is selectively concealed when the product is installed or closed. For example, if the POP label 3 is applied to a refrigerator, then an inner surface of a refrigerator door serves as a selectively concealed face, and all other faces defining an inner space in the refrigerator serve as other selectively concealed faces paired with the above selectively concealed face.

If the POP label 3 is applied to a face other than the inner surface of the refrigerator door, then since the appealing feature display segment 31 is not displaced when the refrigerator door is opened or closed, the appealing feature display segment 31 is displayed in the same position at all times. Therefore, the appealing feature display segment 31 remains displayed in a constant position at all times without being affected by the opening or closing of the refrigerator door. Since the POP sticker in the past is applied to the front face of a refrigerator door, when the refrigerator door is opened, the POP sticker moves with the refrigerator door out of sight of the customer. However, the POP label 3 that is applied to a face other than the inner surface of the refrigerator door remains displayed at all times and attracts attention of the customer for an increased advertisement effect.

In the above case, the prompt message MS for the user may not be printed on the application segment 32, but the application segment 32 and the displacement segment 33 may be printed in a color similar to the color of the area surrounding the application segment 32 and the displacement segment 33. According to such a modification, even when the refrigerator door is opened, the application segment 32 and the displacement segment 33 are less appealing to the eye, letting the appealing feature display segment 31 stand out for strongly impressing the appealing feature AP on the mind of the customer. Alternatively, the application segment 32 may include an appealing feature AP expressed by characters or figures or both in addition to the prompt message MS for emphasizing the appealing feature AP.

The POP label 3 may also be applied to the inner surface of a door. According to such a modification, an appealing feature AP may be printed on not only the face side but also the reverse side of the appealing feature display segment 31. If appealing points AP of different contents are printed on the face and reverse sides of the appealing feature display segment 31, then the different features may be appealed before and after the door is opened, impressing many merits on the mind of the customer for an increased advertisement effect.

In the above embodiment, the car audio unit 2 is packaged with the protective spacer 41 fitted in the recess 21A on the front face 21B of the main body 21, and the POP label 3 is stored in the gap C defined between the front face 21B and the protective spacer 41. However, the car audio unit 2 may be packaged with the operating panel 22 installed on the front face 21B of the main body 21, and the POP label 3 may be stored in the gap C defined between the front face 21B and the rear face 22C of the operating panel 22.

In the above embodiment, the POP label 3 is stored and packaged together with the car audio unit 2 for protection against damage when the car audio unit 2 is packaged, delivered, and unpackaged. However, when the car audio unit 2 is moved in the shop, the POP label 3 may be temporarily stored in the gap C for protection against damage, and after the car audio unit 2 is moved in the shop, the POP label 3 may be pulled out.

In the above embodiment, the appealing feature AP for advertising the car audio unit 2 is printed on the appealing feature display segment 31. However, the appealing feature AP may be printed on the face side of the appealing feature display segment 31, whereas a bar code may also be printed on the reverse side of the appealing feature display segment 31 for sales management.

In the above embodiment, the appealing feature display segment 31 of the POP label 3 is displayed without overlapping the front face 22B. However, the appealing feature display segment 31 may be displayed in overlapping relation to the front face 22B. According to such a modification, the appealing feature display segment 31 may project largely from the front side of the car audio unit 2 so as not to hide the front face 22B, allowing customers to visually recognize the front side of the car audio unit 2 obliquely from above.

In the above embodiment, the appealing feature AP of the car audio unit 2 is printed on the appealing feature display segment 31. However, an instruction manual may be printed on the appealing feature display segment 31. For example, the POP label 3 may be applied to an openable and closable operating panel of a car audio unit 2, with an instruction manual printed on the appealing feature display segment 31 for teaching the user how to handle the operating panel without causing the user to read a separately attached instruction manual.

In the above embodiment, the appealing feature display segment 31 for displaying an appealing feature, the application segment 32 for being applied to the main body, and the displacement segment 33 for displacing the appealing feature display segment 31 jointly make up the POP label 3. However, an appealing feature display segment, an application segment, and a displacement segment, which may be of any of various other structural and functional details, may be combined to make up a POP label.

The POP label according to an embodiment of the present invention may be applicable to furniture, books, automobiles, and other products, and also to microwave ovens, air conditioners, and electronic devices such as various acoustic devices, etc.

Although certain preferred embodiments of the present invention have been shown and described in detail, it should be understood that various changes and modifications may be made therein without departing from the scope of the appended claims.

What is claimed is:

1. A POP label for use on a product having a pair of selectively concealed faces which can be selectively concealed when a member of the product is installed or closed, comprising:
an application segment applied to one of the selectively concealed faces;
an appealing feature display segment displaying an appealing feature of the product; and
a displacement segment interposed between said appealing feature display segment and said application segment, displacing said appealing feature display segment into and out of a space defined between said selectively concealed faces.

2. The POP label according to claim 1,
wherein said displacement segment comprises a flat strip foldable into a bellows configuration.

3. The POP label according to claim 1,
wherein said application segment has a surface applied to said one of the selectively concealed faces and an opposite surface printed with a prompt message for peeling off the POP label when said product is to be used.

4. An electronic device with a POP label applied thereto, said electronic device having a pair of selectively concealed faces which can be selectively concealed when a member of the product is installed or closed, said POP label comprising:
an application segment applied to one of the selectively concealed faces;
an appealing feature display segment displaying an appealing feature of the product; and
a displacement segment interposed between said appealing feature display segment and said application segment, displacing said appealing feature display segment into and out of a space defined between said selectively concealed faces.

5. The electronic device according to claim 4,
wherein said electronic device is mounted for a vehicle.
